(19) United States
(12) Patent Application Publication
(10) Pub. No.: US 2012/0177799 A1
(43) Pub. Date: Jul. 12, 2012

(54) VINEGAR-BASED SOFT DRINK

(75) Inventor: Eduard Nagel, Gumpoldskirchen (AT)

(73) Assignee: GISELA NAGEL GMBH, Gumpoldskirchen (AT)

(21) Appl. No.: 13/260,159

(22) PCT Filed: Mar. 24, 2010
(86) PCT No.: PCT/EP10/53830

§ 371 Date: Dec. 5, 2011

(30) Foreign Application Priority Data
Mar. 24, 2009 (AT) A 777/2009

(51) Int. Cl. A23L 2/54; A23L 2/56; C12J 1/08; A23L 2/02

(52) U.S. Cl. 426/548; 426/599; 426/592; 426/477

(57) ABSTRACT

The invention relates to a beverage mix that is mixed with carbon dioxide as well as a portion table vinegar containing acetic acid. The concentration of the acetic acid in the beverage mix is 0.1% by weight to 1.5% by weight acetic acid, preferably 0.4% by weight acetic acid. Furthermore, there is provided a method for the production of a beverage mix according to the invention.

The invention relates to a beverage mix that is mixed with carbonic acid as well as a portion table vinegar containing acetic acid. Furthermore, there is provided a method for the production of a beverage mix according to the invention.

Worldwide, there is an unbroken demand for alcoholic beverages such as champagne or sparkling wine, which are being consumed in everyday life or on festive occasions. The disadvantages of the consumption of alcoholic beverages are known. Upon the consumption of such beverages, the reaction speed of the consumer will be lowered due to the alcohol content. The high sugar content in alcoholic beverages, furthermore, leads in the case of heavy consumption to a generally undesired gain of weight.

Moreover, in some world regions, the consumption of alcohol is totally prohibited for political or religious reasons.

As a substitute for champagne or sparkling wine, there is thus offered a sparkling alcohol-free soft drink on vinegar basis, which, upon consumption, does not lead to the adverse effects normally associated with the consumption of alcoholic beverages.

The vinegar preparation is one of the oldest methods of food production in mankind. Table vinegar is a sour-tasting seasoning or preservative, produced by fermentation of liquids containing alcohol with acetic acid bacteria. Dependent on cultural sphere and society, for example wine, cider, beer or rice wine as well as liquids containing sugar like grape juice or malt brew may be used for the production of table vinegar.

For example in Germany, table vinegar may currently contain from 5% by weight to 15.5% by weight acetic acid, wherein table vinegar that is commercially available usually has an acetic acid concentration of 5% by weight to 6% by weight. Also acetic acid diluted with water is frequently designated as vinegar; in Germany, however, table vinegar must not contain acetic acid chemically produced without microorganisms.

Herein, there is further referred to high-quality table vinegar produced by means of fermentation, this is fermentation vinegar.

From the state of the art, there are known numerous soft drinks containing a portion of table vinegar.

FR 2 913 313 A1 describes, for example, a liquid, wherein 10 ml wine vinegar, 5 ml honey as well as 0.05 ml of a natural fruit extract are diluted with carbonated mineral water to 200 ml. Concentration data in regard to acetic acid in the wine vinegar, however, are not provided.

In DE 20 2008 014 587 U1 there is mentioned an apple vinegar drink, which is prepared by mixing water and apple vinegar having a content of 5% by weight acetic acid in a mixing ratio of two parts water to one part apple vinegar. The apple vinegar drink is sweetened with an artificial sugar substitute, for example aspartame or saccharin, or it is mixed with carbonic acid. With this apple vinegar drink there is to be achieved a taste comparable to a mixture of apple juice and carbonated mineral water.

US 2003 0091692 A1 describes a vinegar drink, wherein rice wine vinegar with 6% by weight acetic acid, apple juice and a sugar syrup are mixed. Herein, however, there is not made mention of the addition of carbonic acid or carbon dioxide, respectively.

The disadvantage of these soft drinks on the basis of table vinegar known from the state of the art is that there are usually added artificial additives such as artificial sugar substitutes, artificial foreign colourants, artificial preservatives or flavour enhancers to the soft drinks. By mixing with such artificial additives, the natural mineralic flavour of the table vinegar in the beverages is covered or falsified.

Further, it is disadvantageous if beverages on the basis of natural table vinegar are diluted with mineral water. Every mineral water has a respective individual flavour on its own, due to its mineral salt composition or its high mineral salt content, i.e. diluted calcium, magnesium and sodium, respectively. The characteristic mineral composition of the table vinegar is thus adversely covered or falsified by admixture of mineral water with high mineral salt content, usually exceeding 500 mg/l, wherein the mineral salt content is calculated as solid residue. For example the mineral composition of wine vinegar, which substantially corresponds to that of wine, is altered by admixing mineral water, and, hence, a flavour of the alcohol-free soft drink that is similar to wine is sustainably prevented.

If carbonated mineral water is used for admixture to table vinegar, there will be obtained in the beverage usually only some big carbonic acid bubbles due to the overpressure present in mineral waters available on the market. This will, however, lead to a strongly bubbling drink with a rather acid flavour due to the high content of mineral salts, which is rejected by many consumers as being unpleasant.

Usually, there is not provided for such soft drinks with a portion of table vinegar data on the acetic acid concentration in the beverage mix ready to drink, this constituting another disadvantage. In the case of a higher acetic acid concentration in the mixed beverage ready to drink, there is, for example, also obtained an especially pronounced acid flavour, which is also considered as unpleasant by the consumers.

Thus it is the aim of the present invention to provide a soft drink preventing the disadvantages mentioned of the state of the art.

This task is solved with a beverage mix according to the preamble of claim 1 with the features of the characterising part of claim 1. The subclaims relate to especially advantageous embodiments of the invention.

Advantageous in a beverage mix according to the invention, which is mixed with carbon dioxide and has a portion of table vinegar containing acetic acid, is the concentration of the acetic acid in the beverage mix of 0.1% by weight to 1.5% by weight, preferably 0.4% by weight acetic acid.

Such a beverage mix is, due to the moderate concentration of acetic acid in the aqueous mixture, an especially digestible soft drink, which is pleasantly sparkling and particularly stimulating due to the added carbon dioxide and the dissolved carbonic acid, respectively.

The positive effect of the vinegar for the human organism is known from technical literature. As acetic acid is a product inherent of the body and is produced by the human organism on a daily basis, the consumption of, i.e., 100 g table vinegar means for the metabolism of the body that about 5 to 6 g acetic acid are degraded. This amount of acetic acid does not result in imbalance of the acid-base balance of the human body. On the contrary, the consumption of diluted table vinegar will enhance, among others, the body inherent immune system and it will prevent dehydration of the oral mucosa. Furthermore, the consumption of a beverage mix containing diluted table vinegar is especially digestible as well as digestive. The consumption of diluted acetic acid further stimulates the production of hydrochloric acid in the gastric mucosa and thus promotes the degradation of bacteria in the intestines, in this way facilitating the utilization of protein.

Particularly advantageously, in a beverage mix according to the invention the table vinegar used is double-fermented fermentation vinegar of an alcoholic liquid.

By using a fermentation vinegar produced from double-fermented alcoholic beverages, there is guaranteed that the fermentation products contained in the fermentation vinegar such as 2-ketogluconic acid, 5-ketogluconic acid, gluconic acid, citric acid, amino acids as well as 2,3-butylene glycol are present as ingredients in the beverage mix according to the invention and thus guarantee improved compatibility for the body.

Preferably, there is used a fermentation vinegar with a sorbitol content not exceeding 0.3 g/l, preferably not exceeding 0.1 g/l, for a beverage mix according to the invention.

These limit values correspond, for example, to the currently effective regulations of the Österreichischen Lebensmittel-Codex (Austrian Food Law). Wine vinegar, thus, has to have a sorbitol content not exceeding 0.3 g/l. Fermentation vinegar produced from fruit berries, also designated as berry wine vinegar, has to have a sorbitol content not exceeding 0.1 g/l.

A beverage mix according to the invention to which carbon dioxide has been added usefully has overpressure.

In a preferred embodiment a beverage mix to which carbon dioxide has been added has overpressure of up to 5 bar.

In an advantageous embodiment of the invention, a beverage mix to which carbonic acid has been added has overpressure of 2 bar to 5 bar, preferably from 3 bar to 4 bar.

In a further embodiment variant a beverage mix according to the invention to which carbon dioxide has been added has overpressure of up to 3 bar.

By addition of carbon dioxide, wherein dissolved carbonic acid is formed as reaction product of the carbon dioxide with the water of the beverage mix, the pressure of the beverage mix is increased to a level above ambient pressure. The beverage mix is, for example, filled into a champagne bottle and it is pressure-proof closed using a champagne cork or a screw cap. When the bottle is opened, the carbonic acid dissolved in the beverage mix is released, which, comparable to an alcoholic champagne or sparkling wine beverage, especially advantageously provides a finely sparkling beverage. The characteristic flavour of the table vinegar used is made noticeable especially pleasantly by the finely sparkling carbon dioxide bubbles rising.

In a further embodiment, in order to solve the task according to the invention, the concentration of the fruit juice in the beverage mix is 0.1% by weight to 5% by weight in a beverage mix containing further at least a natural fruit juice or a natural fruit juice mixture.

As fruit juice or fruit juice mixture there may be used freshly squeezed natural fruit juices as well as fruit juice concentrates or fruit juice extracts, respectively, each unblended or in any kind of mixtures from several fruit juice types. By addition of the fruit juice, the flavour of the table vinegar of the beverage mix is smoothened, and it is made especially digestible. The cited concentration of the fruit juice is advantageous, in order to obtain a still more noticeable flavour of the added fruit juice in the prepared beverage mix in the course of the dilution of the table vinegar with water, if an acetic acid concentration of the beverage mix is adjusted to 0.1% by weight to 1.5% by weight. By addition of the natural fruit juice, the natural fructose as well as the natural colourants contained therein and the natural antioxidants are added in a low concentration to the beverage mix.

As a fruit juice there is usefully added a pomegranate juice as a fruit juice to a beverage mix according to the invention.

Pomegranate juice is especially well-tasting and harmonizes excellently as a fruit juice additive with the mineral composition of table vinegar. The fructose contained in the pomegranate juice neutralizes the acidic flavour of the acetic acid and, hence, guarantees an especially well-tasting beverage mix.

According to a further characteristic of the invention, the sugar content of the beverage mix is lower than 15 g/l, preferably lower than 2 g/l.

The beverage mix according to the invention is low in calories because of the low sugar content, this constituting another advantage. The natural fructose contained in the optionally added fruit juice, which is added to the beverage mix low in calories in a low concentration, usually suffices for sweetening. If there are to be added fruit juices or fruit juice mixtures to the beverage mix, their content of natural fructose not being sufficient in order to neutralize the acid acetic acid flavour, there may also be added natural sugar, for example cane sugar or granulated sugar, for sweetening the beverage mix up to a sugar content of not more than 15 g/l.

In a further development of the invention, a beverage mix is devoid of artificial sugar substitutes such as, i.e., aspartame or saccharin.

An addition of such artificial sugar substitutes would adversely modify the harmonious flavour of the natural flavours of the beverage mix according to the invention.

In a preferred embodiment of the invention the beverage mix has an ethanol content not exceeding 0.1% by weight, preferably not exceeding 0.01% by weight.

Advantageously, a beverage mix according to the invention, hence, is substantially devoid of alcohol. Any residual alcohol still present may only be detected in the beverage mix in an amount determinable by analysis.

Thus the consumption of the beverage mix according to the invention as a well-tasting soft drink is advantageously possible especially in countries with a strict ban on alcohol. In regard to visual impression with its fine mousseux comparable to champagne or sparkling wine, respectively, as well as in regard to its flavour, the beverage mix according to the invention is similar to a wine fermented to champagne—with the advantage, however, of substantially not containing any alcohol.

Usefully, a beverage mix according to the invention is devoid of artificial flavour enhancers and/or artificial colourants and/or preservative additives.

Artificial flavour enhancers such as glutamic acid and the sodium, potassium and calcium salts thereof may be added to the table vinegar commercially available, depending on the respective quality. There may also be present artificial colourants or artificial preservatives in the table vinegar. The table vinegar used for the beverage mix according to the invention is advantageously devoid of such artificial additives. Thus the beverage mix according to the invention is produced exclusively from high-quality natural materials, and its consumption is healthy.

In a development of the invention there is stated a method for the production of a beverage mix further containing drinking water, wherein the table vinegar is mixed with drinking water having a mineral salt content not exceeding 500 mg/ml, preferably not exceeding 300 mg/ml, calculated as a solid residue, with the optional addition of at least a natural fruit juice or a natural fruit juice mixture, wherein there is finalizingly added carbon dioxide under overpressure.

Advantageously, drinking water or spring water, respectively, with a low content of dissolved mineral materials is selected for diluting the table vinegar or for producing the beverage mix, respectively. The liquid components table vinegar, drinking water as well as natural fruit juice or fruit juice mixture, respectively, are therefore mixed with each other in no particular order. It is also conceivable that the liquid components following a certain recipe are mixed with each other simultaneously. Upon preparation of the liquid mixture, its composition or the acetic acid concentration thereof may be examined. Subsequently, carbon dioxide is added under overpressure, and the beverage mix according to the invention may be filled into pressure-proof bottles and closed.

It has been shown that in the production of the beverage mix with table vinegar and/or fruit juice using mineral water, in particular carbonated mineral water, with a mineral salt content exceeding 500 mg/l, wherein the mineral salt content is calculated as a solid residue, instead of drinking water or spring water, respectively, with a lower content of dissolved minerals, there are formed undesired big carbonic acid bubbles in the beverage mix. Such big bubbles or droplets, respectively, of rising carbon dioxide lead, during consumption, to a strongly sparkling, unpleasantly acidic taste in the mouth and on the gustatory papillae of the tongue, which adversely covers the pleasant taste of the ingredients of the soft drink.

In contrast thereto, the carbon dioxide, which is added under overpressure to the beverage mix diluted with drinking water with a low mineral salt content and which rises upon opening of the bottle in the form of extremely fine bubbles in the beverage mix, makes the pleasant, wine-like taste of the alcohol-free beverage mix according to the invention clearly stand out.

Comparable to champagne or a sparkling wine, also the beverage mix according to the invention is especially appealingly, for example, filled into a pressure-proof champagne bottle with a cork cap or a screw cap and then marketed as an alcohol-free alternative to champagne or sparkling wine.

1. A beverage mix, comprising:
carbon dioxide;
table vinegar containing acetic acid, wherein:
the concentration of the acetic acid in the beverage mix is 0.1% by weight to 1.5% by weight acetic acid; and
the table vinegar includes a fermentation vinegar double-fermented of an alcoholic liquid, with a sorbitol content not exceeding 0.3 g/l; and
at least a natural fruit juice or a natural fruit juice mixture, wherein the concentration of the natural fruit juice in the beverage mix is from 0.1% by weight to 5% by weight.

2. A beverage mix according to claim 1, wherein the fruit juice comprises a pomegranate juice.

3. A beverage mix according to claim 1, wherein the sorbitol content does not exceed 0.1 g/l.

4. A beverage mix according to claim 1, wherein the beverage mix has overpressure.

5. A beverage mix according to claim 4, wherein the has overpressure is in a range less than 5 bar.

6. A beverage mix according to claim 4, wherein the overpressure is in a range from 2 bar to 5 bar.

7. A beverage mix according to claim 4, wherein the overpressure is in a range less than 3 bar.

8. A beverage mix according to claim 1, wherein the beverage mix has a sugar content not exceeding 15 g/l.

9. A beverage mix according to claim 1, wherein the beverage mix is devoid of artificial sugar substitutes.

10. A beverage mix according to claim 1, wherein the beverage mix has an ethanol content not exceeding 0.1% by weight.

11. A beverage mix according to claim 1, wherein the beverage mix is devoid of artificial flavour enhancers and/or artificial colourants and/or preservation additives.

12. A method for the production of the beverage mix of claim 1, comprising:
mixing the table vinegar with drinking water having a mineral salt content not exceeding 500 mg/l, calculated as a solid residue; and
adding carbon dioxide under overpressure.

13. A beverage mix according to claim 1, wherein the concentration of the acetic acid in the beverage mix is approximately 0.4% by weight acetic acid.

14. A beverage mix according to claim 6, wherein the overpressure is in a range from 3 bar to 4 bar.

15. A beverage mix according to claim 8, wherein the sugar content does not exceed 2 g/l.

16. A beverage mix according to claim 10, wherein the ethanol content does not exceed 0.01% by weight.

17. A beverage mix according to claim 1, wherein the table vinegar is a wine vinegar.

18. A method according to claim 12 for the production of the beverage mix, wherein the mineral salt content does not exceed 300 mg/l.

19. A method according to claim 12 for the production of the beverage mix, further comprising adding at least one natural fruit juice or a natural fruit juice mixture.
